(19) United States
(12) Patent Application Publication
(10) Pub. No.: US 2010/0209895 A1
(43) Pub. Date: Aug. 19, 2010

(54) Playing Cards with the Added Function of Teaching and Learning English Phonics

(76) Inventors: Geoffrey S. RICCIARDI, Hualien (TW); Jih-Xian Lin, Hualien (TW); Terry D. Sommers, Hualien (TW)

Correspondence Address: Jackson Intellectual Property Group PLLC, 106 Starvale Lane, Shipman, VA, 22971, US

(21) Appl. No.: 12/359,298

(22) Filed: Jan. 24, 2009

(51) Int. Cl. G09B 1/00; G09B 19/02

(52) U.S. Cl. 434/167; 434/188

(57) ABSTRACT

Playing cards with an added function of teaching and learning English phonics are provided. In addition to the index labels of A to K and the corresponding symbols of clubs, diamonds, spades, and hearts printed on conventional playing cards to enable conventional functions thereof, the disclosed playing cards are provided with single letters or letter strings from the English alphabet, exemplary English words, image patterns, and serial numbers to facilitate teaching, self-learning, and guided learning of pronunciation and numbers.

### BACKGROUND OF THE INVENTION

1. Technical Field

The present invention relates to playing cards. More particularly, the present invention relates to playing cards with an added function of teaching and learning English phonics, wherein each of the playing cards is provided with a single letter or a letter string from the English alphabet, an exemplary English word, an image pattern, and a serial number, in addition to one of the conventional index labels from A to K and a corresponding symbol of a club, diamond, spade, or heart, so as to facilitate teaching and learning of pronunciation and numbers.

2. Description of Related Art

Conventional playing cards are primarily used in card games such as bridge or those that compare the values of played cards for competition or gambling purposes. A complete set, or deck, of conventional playing cards consists of 54 cards including 13 ranks, from A to K, in each of the four suits of clubs, diamonds, spades, and hearts, and two Jokers. Thin and compact in size, the playing cards can be stored easily at home and carried easily to provide entertainment whenever needed.

In view of the aforesaid properties such as convenient storage and portability of the playing cards, manufacturers have added phonetic symbols, letters, or words in different languages to the playing cards to provide extra functions. However, the resultant playing cards, or learning cards, do no more than show the additional marks.

Recently, as English continues to be the mainstream language around the globe, people from non-English speaking countries have become more and more enthusiastic about learning English, in which English phonics is one of the most popular and most efficient methods for learning English pronunciation.

There are a good number of phonetic symbols or phonetic letters in English as well as in Chinese and Japanese. For example, there are approximately 30 to 40 phonetic symbols, also known as Zhuyin Fuhau or Bopomofo, in the phonetic system of Mandarin Chinese. In English phonics, on the other hand, there are about 44 sounds including consonants, long and short vowels, single sounds, compound sounds, diphthongs, blended sounds, etc. Developed from these 44 sounds are as many as 76 basic pronunciation units and 29 derived sounds.

The traditional approaches of teaching and learning pronunciation can only be assisted by books and the blackboard or whiteboard, making it extremely difficult and inconvenient for one to learn the proper use of all the sounds. However, the playing cards disclosed herein provide an efficient, convenient, and effective way of arranging the numerous, existing pronunciation concepts.

Based on the conventional playing cards, the present invention creates 108 units which are further divided into a consonant system shown in blue fonts and a vowel system shown in orange fonts. Through selective combination of the plurality of units, an effective, convenient, rapid, and creative way of learning is provided that satisfies the requirements of phonics.

### BRIEF SUMMARY OF THE INVENTION

To overcome the shortcomings and inconvenience of the traditional learning cards, the present invention provides playing cards with an added function of teaching and learning English phonics. It is well known that the English language is a system composed of phonetic transcription letters. If one knows the sound represented by each letter or each combination of letters, he or she can pronounce whatever word correctly without understanding the meaning thereof. The disclosed subject matter is intended to train users to pronounce, but not understand, English words upon reading the words.

The playing cards with the added function of teaching and learning English phonics according to the present invention are integrated with the concept of the conventional playing cards and pocket sized so that learning is no more confined to classrooms. Furthermore, the spirit of entertainment and competition of the conventional playing cards is preserved in the present invention to bring fun to the otherwise dull process of learning pronunciation.

In addition to the four symbols of the club, diamond, spade, and heart and the corresponding index labels from A to K of the conventional playing cards, the playing cards with the added function of teaching and learning English phonics according to the present invention are provided with exemplary figures to accompany exemplary words and thus create more learning possibilities. For example, a teacher can show a playing card No. 20 of the present invention to students and ask them to describe the location of the ball, or the colors of the fence and the grass, or the weather condition depicted on the playing card. As well, the teacher can also use the serial number at the bottom edge of each playing card to teach numbers from 1 to 108.

Therefore, the playing cards with the added function of teaching and learning English phonics according to the present invention are unique in that they allow spelling and pronunciation techniques to be taught and learned in a fun way through a multifunctional design.

Another objective of the playing cards with the added function of teaching and learning English phonics according to the present invention is to make use of people's natural keenness for competition and challenges while stimulating the instinct to learn. For instance, a user who correctly pronounces the letter or word on a playing card can get the score shown on the playing card. Take a playing card of the letter “y” for example. A user who pronounces the letter accurately can get eight scores. If the word pronounced is spelled by putting several playing cards together, the scores on the playing cards in use are added to produce the final score. When games are incorporated into the learning of pronunciation, a learner shows better performance and response than when textbooks are the only teaching material.

Hence, the inventor of the present invention aims to “format” the teaching and learning of pronunciation so as to enhance learning effects, stimulate the instinct of learning, and enable rapid understanding of the concept of pronunciation. Apart from the teaching and learning of pronunciation, the present invention also allows the spelling of English words by selectively combining different playing cards together. The inventor believes that an affordable and multifunctional way of learning can be achieved by two complete sets of playing cards, i.e., a total of 108 playing cards, with the added function of teaching and learning English phonics. Moreover, at a time when public awareness of environmental protection is high, the present invention uses paper more economically than the traditional approaches of teaching and learning pronunciation, which depend on books of at least 100 pages each. Therefore, it is hoped that, with the foregoing features, the disclosed subject matter meets the requirements for patent application and will be granted with a patent.

### BRIEF DESCRIPTION OF THE SEVERAL VIEWS OF THE DRAWINGS

The invention as well as a preferred mode of use, further objectives and advantages thereof will be best understood by referring to the following detailed description of an illustrative embodiment in conjunction with the accompanying drawings, wherein:

FIG. 1 shows one of playing cards with the added function of teaching and learning English phonics according to the present invention, wherein the playing card is provided with a single letter;

FIG. 2 shows another one of the playing cards with the added function of teaching and learning English phonics according to the present invention, wherein the playing card is provided with compound letters; and

FIG. 3 shows three of the playing cards with the added function of teaching and learning English phonics according to the present invention, wherein the playing cards are grouped together to spell a word.

### DETAILED DESCRIPTION OF THE INVENTION

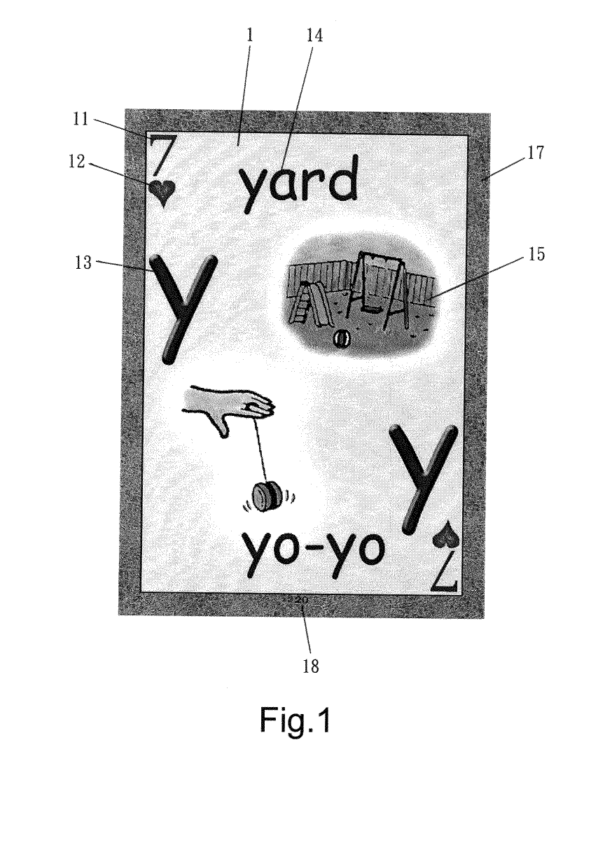

The present invention provides one or two complete sets of playing cards, i.e., a total of 54 or 108 playing cards, with an added function of teaching and learning English phonics. Please refer to FIG. 1 for a playing card 1 as a representative example of the playing cards. The playing card 1 is provided with a traditional index label 11 (e.g., the number “7”) and a traditional symbol 12 (e.g., the symbol of a heart). Additionally, a portion of the playing cards 1 are each provided with a single letter 13 (e.g., the letter “y”), an exemplary English word 14 (e.g., “yard” and “yo-yo”), and a pattern 15 (e.g., the images of a yard and a toy attached with a string for unwinding or rewinding).

The single letter 13 belongs either to a consonant system or a vowel system. The two systems are printed with different colors, respectively, for easy distinction so as to facilitate teaching and learning.

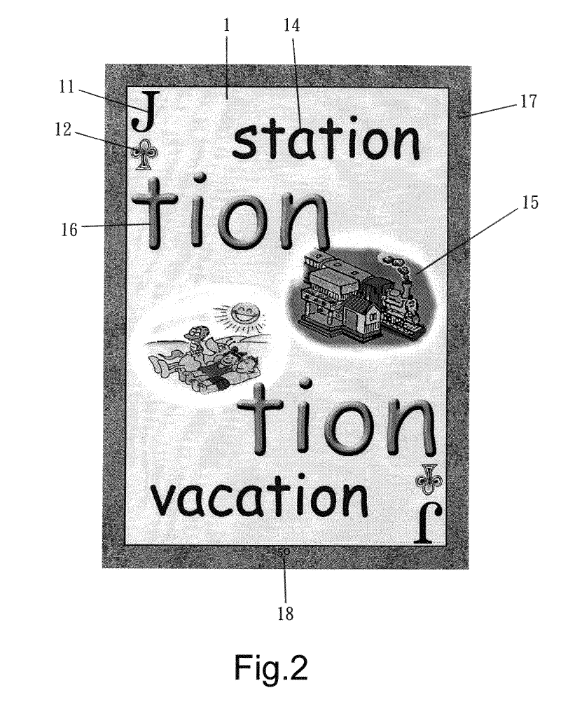

Referring to FIG. 2, the letters shown on the aforesaid portion of the playing cards 1 according to the present invention include compound letters 16 consisting of plural letters (e.g., “tion”, “oe”, and “ture”).

The playing cards 1 with the added function of teaching and learning English phonics according to the present invention each has a perimeter provided with a colored or patterned frame 17 by which to distinguish between the two sets of playing cards. In other words, the frames 17 of the playing cards that belong to the same set are the same color. Thus, the two sets of playing cards, when mixed together for use, can be sorted with ease and rapidity.

Besides, as a teaching aid for children to learn numbers, a serial number 18 (e.g., the serial number “16”) is provided at a bottom edge of each of the playing cards 1 with the added function of teaching and learning English phonics according to the present invention.

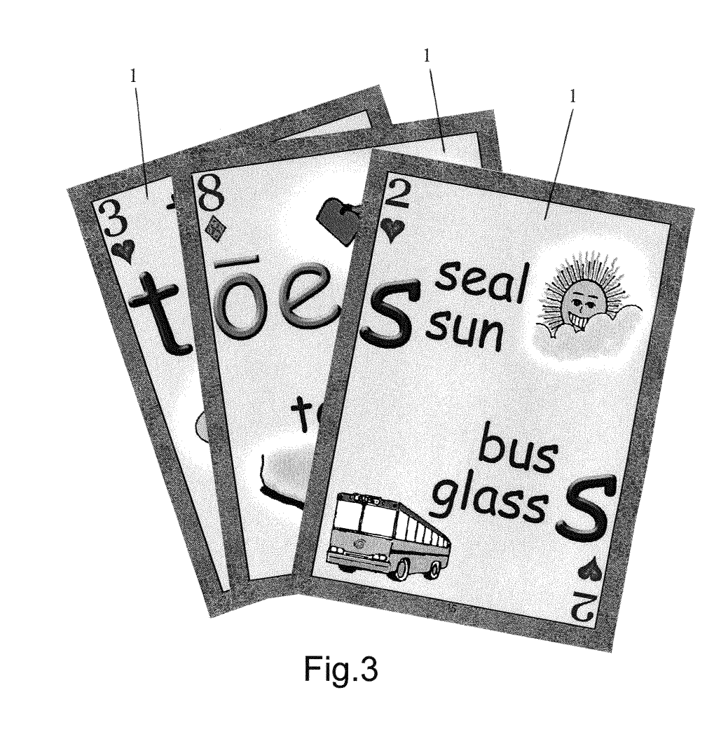

Based on the aforesaid design, the playing cards with the added function of teaching and learning English phonics according to the present invention can be used by learners as well as teachers not only for entertainment in the same way as the conventional playing cards, but also for the teaching and learning of letters, pronunciation, exemplary words accompanied by image patterns thereof, and numbers, as shown in FIG. 1; or for the teaching and learning of English words spelled by grouping several of the playing cards together, as shown in FIG. 3.

1. Playing cards with an added function of teaching and learning English phonics, consisting of one or two sets of playing cards, i.e., with either 54 or 108 playing cards, each comprising an index label and a symbol, wherein a portion of the playing cards are each provided with a single letter, an exemplary English word, and an image pattern, and the letters on the portion of the playing cards include compound letters consisting of plural letters.

2. The playing cards with the added function of teaching and learning English phonics as claimed in claim 1, wherein the letters on the portion of the playing cards are divided into a consonant system and a vowel system, and the letters of the two systems are printed with different colors, respectively.

3. The playing cards with the added function of teaching and learning English phonics as claimed in claim 1, wherein each said playing card has a periphery provided with a colored or patterned frame by which to distinguish between the two sets of playing cards.

4. The playing cards with the added function of teaching and learning English phonics as claimed in claim 1, wherein each said playing card has a bottom edge provided with a serial number as a teaching aid for children to learn numbers.
